(19) United States
(12) Patent Application Publication
(10) Pub. No.: US 2011/0002762 A1
(43) Pub. Date: Jan. 6, 2011

(54) Site Dumping Moving Floor Hopper Method and Apparatus

(76) Inventors: Jeff Horan, Mt. Vernon, WA (US); Matt Anderson, Oak Harbor, WA (US)

Correspondence Address: Jellett Law, PS;Matthew Jellett, Esq., 910 Harris Ave, Suite A205, BELLINGHAM, WA, 98225, US

(21) Appl. No.: 12/784,749

(22) Filed: May 21, 2010

Related U.S. Application Data
(60) Provisional application No. 61/222,975, filed on Jul. 3, 2009.

(51) Int. Cl. B60P 1/04

(52) U.S. Cl. 414/470; 414/813; 414/491

(57) ABSTRACT

A site dumper elevation, rotation, and moving floor hopper implement. The implement includes a material bed for conveying material from one site location to another. The material bed has a bed side wall and a first bed gate. The bed side wall defines an upper bed wall edge and a lower bed wall edge. The material bed further has an open top, a bed tilt hinge arranged near said first bed gate and a moving floor for transferring the material towards or away from the first bed gate. The moving floor defines the bottom wall of the material bed. A first lift arm is configured to tilt the material bed and the moving floor about the bed tilt hinge at an angular distance. An undercarriage is configured to support the material bed, the moving floor, and the lift arm. The undercarriage further is configured to rotate a rotational distance about a vertically aligned axis.

### RELATED APPLICATIONS

This application claims priority benefit of U.S. Ser. No. 61/222,975 filed 3 Jul. 2009.

### BACKGROUND

U.S. Pat. No. 5,118,244 discloses a truck body structure and driven moving floor for self unloading, where a self unloading load hauling box for use on a towed carriage or carried by a powered motor vehicle is provided where the box is a rigid unit having a bottom wall with the floor plate and side walls and front end wall projecting up from the rigid bottom wall. An endless belt is looped around the bottom wall and runs on a driven roller at the rear end and an idler roller at the front end of the box. The endless belt is driven through an arc of selected length at spaced apart intervals to unload contents from the box. The jerky action from intermittently driving the belt has a tendency to cause a vibration, which loosens the contents in the box and thus results in a relatively even discharge during unloading.

U.S. Pat. No. 6,200,082 discloses a rolling floor for a truck or trailer box for hauling and unloading objects. The rolling floor includes a floor portion and a pair of wall portions upwardly extending from lateral sides of the floor portion. The floor portion has a plurality of rollers extending across. An endless belt wraps around the floor portion and rests on the rollers of the floor portion. A drive mechanism drives the belt.

U.S. Pat. No. 5,102,285 discloses a trailer with continuous conveyor bed, where a trailer assembly is provided for receiving, transporting and discharging flowable bulk material. Trailer assembly includes a pair of opposing generally vertical sidewalls which are secured to a frame member and converge downwardly and inwardly. Flexible flat members extend downwardly from the bottom edges of the sidewalls. The sidewalls are joined by a front end wall and a rear wall to define a bin having an open floor. The conveyor is provided as the floor for the bin with the conveyor extending beneath the sidewalls and having a width greater than the distance between the bottom edges of the sidewall and positioned closely adjacent to the terminal edges of the flexible flat members. The conveyor includes a pair of opposing endless chains which are mounted about sprockets with the chains connected by cross members.

U.S. Pat. No. 4,436,226 discloses a material metering device for particulate matter where backups and caking of the material is inhibited by the provision of a live metering gate which consists of an upper blocking section and a lower material contacting surface. The lower surface is continually moved in the direction of material flow at a speed approximately equal or slightly greater than the material flow speed. An elongated rotatable rod carried at the lower end of the blocking plate preferably provides the material contacting surface. The gate is vertically adjustable so that the volumetric flow rate of material can be controlled.

U.S. Pat. No. 5,772,389 discloses a combined dump truck and spreader apparatus, for selectively dumping and spreading material. The apparatus includes a truck chassis and body for receiving and dispensing the materials. The body has a first and second end and a first and second curved sidewall. The body is secured to the chassis and the tailgate which is secured to the first end of the body. A conveyor is disposed within the body and extends between the first and second ends thereof for conveying the materials along the body. The tailgate defines an opening which cooperates with the conveyor for permitting the flow of the materials.

U.S. Pat. No. 6,557,944 discloses a dump truck apparatus with a removable hopper where the apparatus is capable of adapting a vehicle for use in either a dump truck mode or spreader truck mode and includes a dump body unit and a removable hopper. The main frame attaches to the vehicle and supports the dump body. The dump body has a flatbed and a lengthwise channel which contains an embedded conveyor. In the dump truck mode, the conveyor is uncovered and the hopper is attached to the dump body so that an aperture at the hopper's base is aligned over the conveyor. Gravity fed materials may then be conveyed along the body to an attached spreader for dispersion.

U.S. Pat. No. 6,092,966 discloses a multipurpose dump unit for vehicles where the unit is designed to be mounted on a vehicle for hauling, dumping, spreading and the collection of refuse as well as for distributing salt, sand and other aggregates. The unit has a single dump body with a sloping fixed end gate and a longitudinally extending end gate and a longitudinally extending conveyor along the bottom of the dump body. The unit is provided with a spreader mechanism at the exit gate to facilitate spreading of salt, sand and other aggregates. The unit is pivotably mounted near its rear end so that it can be lifted by hydraulic cylinders for dumping, spreading aggregate, asphalt etc. The dump unit can be sized so that the vehicle can navigate narrow streets and alleys and is mounted to a height with sides of a height to meet the requirements for manual loading.

U.S. Pat. No. 7,090,305 discloses a vehicle dump body elevation device, kit and method relating thereto where the device has at least one hinge assembly for attaching a dumb body to a vehicle frame and at least one hoist having a lower end pivotally attached to the vehicle frame and an upper end pivotably attached to the dump body. The kit permits easy installation without modification of a vehicle's structural components and it permits dumping over the vehicle's bumper and other frame mounted accessories.

U.S. Pat. No. 4,592,593 discloses a scissor frame lift apparatus for dump trucks, where the scissor frame includes an upper and lower pivotably interconnected leg members which in turn are pivotably connected at opposite ends to the underside of the dumb body and the chassis of the track respectively. Lift cylinders extend along opposite sides of the leg members between the dump body and the chassis to elevate and tilt the dump body. The upper limit of advancement of the dump body is controlled by the frame stop member which defines an angular extension of one of the leg members and moves into engagement with the other of the leg members before cylinders reach their full limit of extension.

U.S. Pat. No. 6,257,670 discloses a side dump trailer, which has a trailer body pivotably mounted on wheeled frame to enable the material within the trailer body to be dumped from one side of the trailer. The body is pivotably moved with respect to the wheeled frame by means of a plurality of horizontally spaced apart scissor lift assemblies positioned beneath body of the trailer.

U.S. Pat. No. 3,159,229 discloses an articulated chassis for a vehicle where the vehicle has a front and rear pair of power driven wheels respectably supported from front and rear chassis portions which are capable of being relatively articulated to steer the vehicle and has particular but not exclusive reference to a vehicle such as dumper or forklift truck. The main object of the invention is to enable such a vehicle to be steered without differential slip between the front and rear wheels.

### BRIEF DESCRIPTION OF THE DRAWINGS

FIG. 1 is a front elevational view of the CASD with moving floor hopper;

FIG. 1A is a side detail view of the moving floor hopper;

FIG. 2 is a front elevational view of the CASD with moving floor hopper in an elevated position;

FIG. 3 is a side elevational view of the CASD with moving floor hopper;

FIG. 4A is a detail elevational view of the high speed conveyor at the forward end;

FIG. 4B is a detail elevational view of the high speed conveyor at the rearward end;

FIG. 5 is a schematic flow chart of the method of use of the moving floor hopper;

FIG. 6 is a schematic flow chart of the method of operating a moving floor implement.

### DESCRIPTION OF THE PREFERRED EMBODIMENTS

Generally speaking what is provided is a moving floor hopper which can be placed on a small dump truck or other job site hauling vehicles such as a compact articulated site dumper. The moving floor hopper may have the capacity to carry approximately 3½ yards of payload or approximately 7,700 pounds of material. A range may include anywhere from about 1 to 9 metric tons or about 1.1 to 9.9 US tons. The moving floor hopper combined with say for example, a compact articulated site dumper enables the user to load the moving floor hopper with material, transport the material to another place on the job site, and then operate the moving floor hopper to meter a precise quantity of material onto the new site location.

A description of the present embodiment of the moving floor hopper combined with, in this particular embodiment, a compact articulated site dumper will now be provided. While operation of the moving floor hopper is provided on the compact articulated site dumper, it is readily conceived that additional job site hauling vehicles or site dumpers if properly equipped can be utilized for operation of the moving floor hopper.

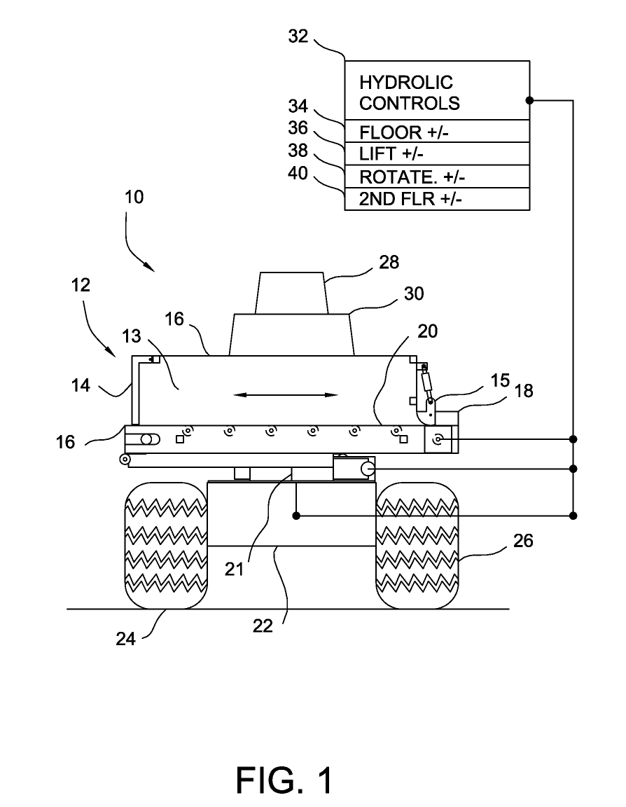

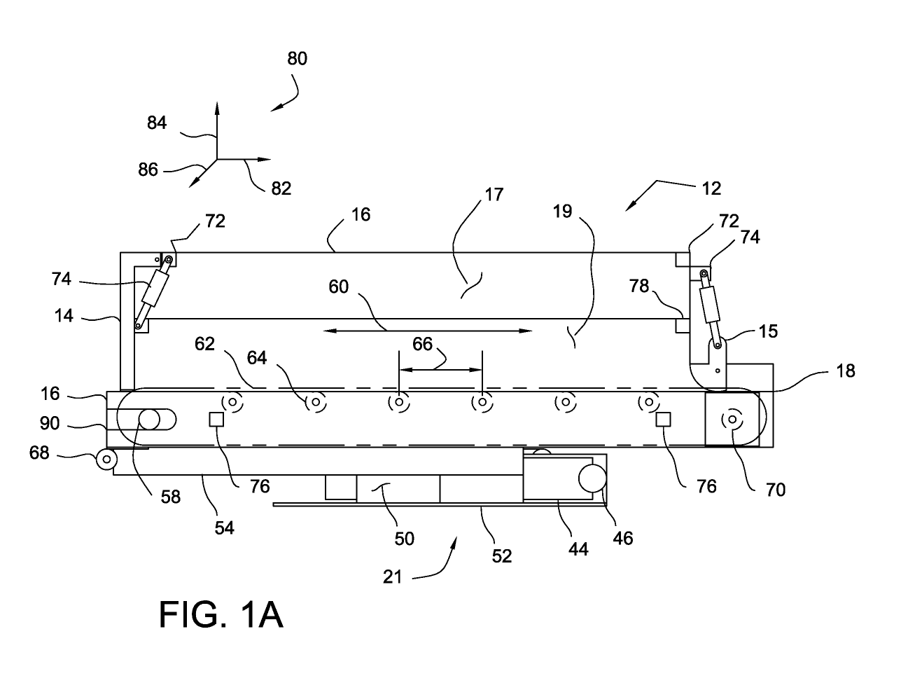

Referring to FIG. 1, a moving floor hopper in combination with a compact articulated site dumper 10 is shown. In this particular embodiment, the operator's seat 28 and the control mechanisms 30 enable the operator to utilize the hydraulic controls 32 to move the floor in a foreword or rearward direction by actuating a floor component 34. Furthermore, the moving floor bed or moving floor hopper 12 can be hydraulically lifted or rotated about the forward end 16 of the bed using the lift component 36. In this particular embodiment, the moving floor hopper 12 is configured as a rectilinear hopper and can actuate about a center point or turn about a turntable located on the chassis 22 of the compact articulated site dumper. In this particular embodiment the turntable is a hydraulic turn table. The hydraulic controls 32 enable the user to rotate the moving floor hopper plus or minus 90° for a total of 180° rotation using the rotation component 38. The user can also operate a second moving floor utilizing a second floor component 40 which will be discussed below.

There are three main components of the site dumper elevation, rotation, and moving floor implement or in other words moving floor hopper 12. They include the main material bed 13 which includes a bed side wall including two equal but opposite parallel spaced side walls 16 as well as a front bed gate 14 and a rear bed gate 15 where the gates can be operated by a linear gate actuator 74 as seen in FIG. 1A. The bed side wall includes and upper bed wall edge and a lower bed wall edge. The material bed has an open top for placement of the material into the bed.

The second main component of the moving floor hopper 12 is the moving floor 20 and the third main component is the undercarriage 21. In this particular embodiment the compact articulated site dumper has an articulating chassis 22 which supports the moving floor hopper 12 as well as provides for the axle and drive end connection with the wheels 24 and 26. All three main components will be discussed in full detail.

In general, the moving floor is designed to transfer material towards and away from the bed gates. Because the moving floor spans from one wall to another, it defines the closed bottom wall of the material bed.

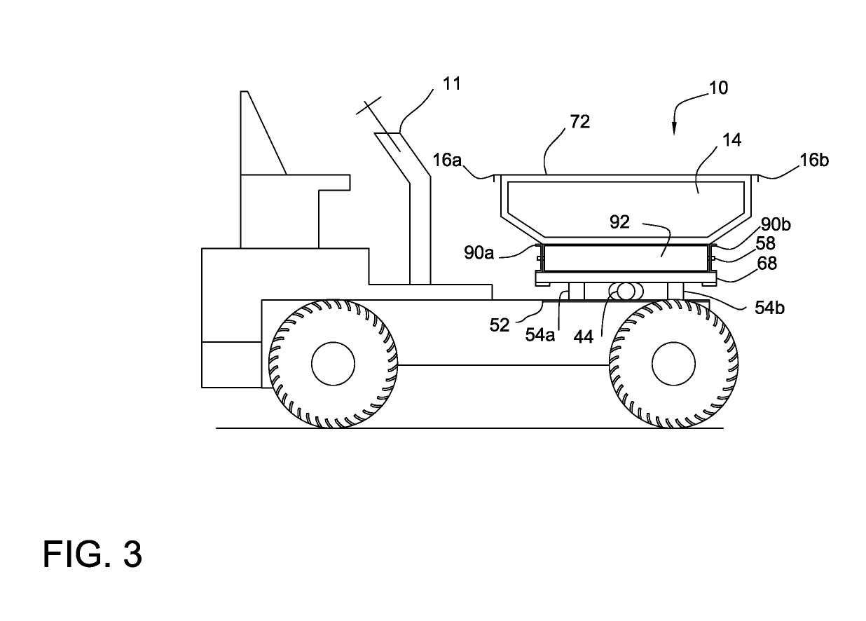

Referring to FIG. 1A, and FIG. 3 the moving for hopper 12 is shown as a rectilinear bed where the side walls 16 extend the longitudinal direction 82, the shorter bed gates 14 and 15 are extend the transverse direction 86 thus creating a rectilinear bed, or rectilinear hopper. The hopper itself is not limited in shape and can for example be trapezoidal in shape, circular or oval, or any other shape which makes the hopper usable for receiving and depositing material at the jobsite.

The hopper has a tube steel top frame 72 which defines the upper limit of the top wall of the side walls 16 and the front and rear gates 14 and 15 respectively. The sidewalls 16 have a top vertical wall 17 and a sloped wall 19 where the sloped wall enables the carried material to fall onto the moving floor 62. The forward or front gate 14 and the rear gate 15 are each actuated for opening and closing through a 12V linear gate 74 mounted on the frame of the hopper.

In general, the moving floor is an endless loop moving floor which is arranged between the two equal but opposite longitudinally aligned floor supports which span from the forward end to the rearward end of the material bed. The endless loop moving floor rotates about a forward roller bearing arranged at the forward end of the material bed and a rearward roller bearing arranged at the rearward end of the material bed.

The moving floor 62 in this particular embodiment is constructed of a series of floor rollers 64 equidistantly spaced along with the longitudinal length 82 of the hopper at a roller spacing 66 which in this particular embodiment is approximately 12″. The rollers 64 span between two longitudinally aligned floor supports or in this particular embodiment two outside C-channel bed rail frames 90A and 90B as can be seen in FIG. 3. The moving floor track is pulled taut by a take-up roller bearing 58 at the forward end 16 of the hopper. At the aft end or rearward end 18 of the hopper a floor hydraulic with roller 70 actuates the moving floor 62, 20 in the forward or rearward direction depending upon the use of the floor control component 34 as seen in FIG. 1. The C-channel bed rail frame 90A and 90B are each connected to a bed tilt hinge 68 at the forward end 16 of the moving floor. A small crossbeam 76 at the forward and rearward ends of the moving floor provides for additional cross bracing creating a box frame between the crossbeams and the C-channels.

The entire moving floor hopper 10 rotates on a turntable 52 which is hydraulically operated and is attached to the compact articulated site dumper. In order to support and operate the moving floor hopper 10, an undercarriage 21 is provided for cantilevered support of the moving floor hopper as well as hydraulic operation for lifting and rotating the hopper on the turntable 52. Directly connected to the turntable 52 is an arm stay 50a & 50b which provides a vertical space between the turntable 52 and the bracket arm or undercarriage bracket arms 54a & 54b (also referred to as 54) supporting the main load of the moving floor hopper. The bracket arm 54 has an equal but opposite bracket arm 54b and they extend longitudinally out from the arm stays 50A and 50B to support the bed tilt hinge 68. The bed tilt hinge 68 provides radial rotation of the moving floor hopper about the hinge for dumping of the material in the hopper bed.

A lift arm which in this particular embodiment is a clamshell hydraulic 44 is provided between the bracket arm's 54A and 54B and the hydraulic 44 provides the radial lift and tilt of the moving floor hopper about the bed tilt hinge 68.

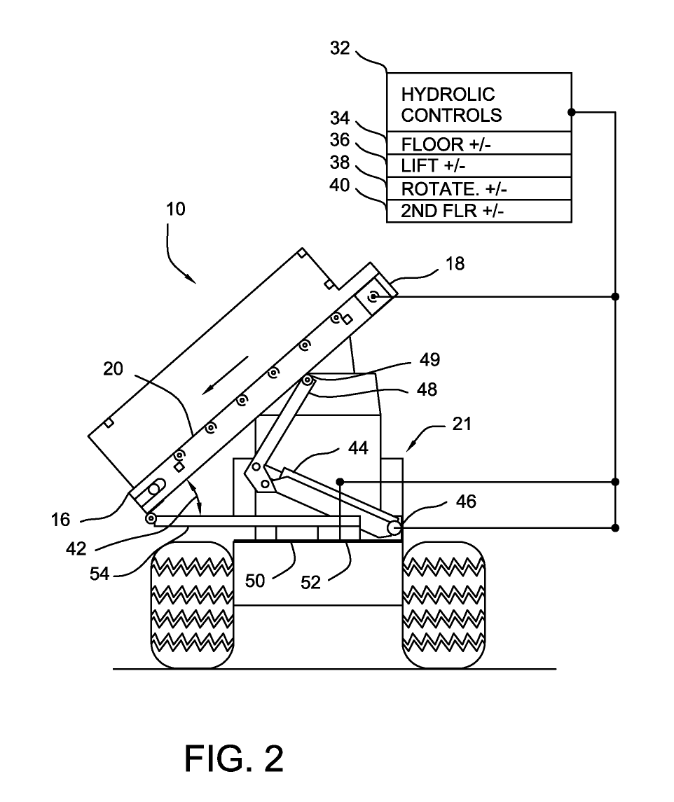

Referring to FIG. 2, the moving floor hopper 10 is shown at a lift/tilt angle position 42 of an angle in this particular embodiment not to exceed 49°.

As the user actuates the hydraulic controls 32 and specifically the lift component 36, the hydraulic 44 exerts a lifting force on the lifting arm 48 which is attached to the undercarriage at a lower pivot hinge 46 and to the moving floor and specifically the longitudinally aligned floor supports at an upper pivot hinge 49. The lifting force from the hydraulic 44 exerts positive pressure on the left arm 48 of the clamshell hydraulic 44 thus causing the material bed and moving floor to tilt about the bed tilt hinge 68 causing the material in the hopper to spill towards the forward end 16 of the hopper itself. When the operation is complete, the user releases the hydraulic pressure built up in the hydraulic 44 then the moving floor bed and hopper 10 lower back to the original position.

While not shown in the present embodiment, in lieu of a clam shell hydraulic, a scissor lift may be incorporated into the moving floor hydraulic system, or a combination of both the clam shell and scissor lift hydraulics for lift and tilt of the bed.

Referring to FIG. 3, the hydraulic 44 is situated in the center of the undercarriage 21 where each of the undercarriage bracket arms 54A and 54B are on the outer edges of the turntable 52.

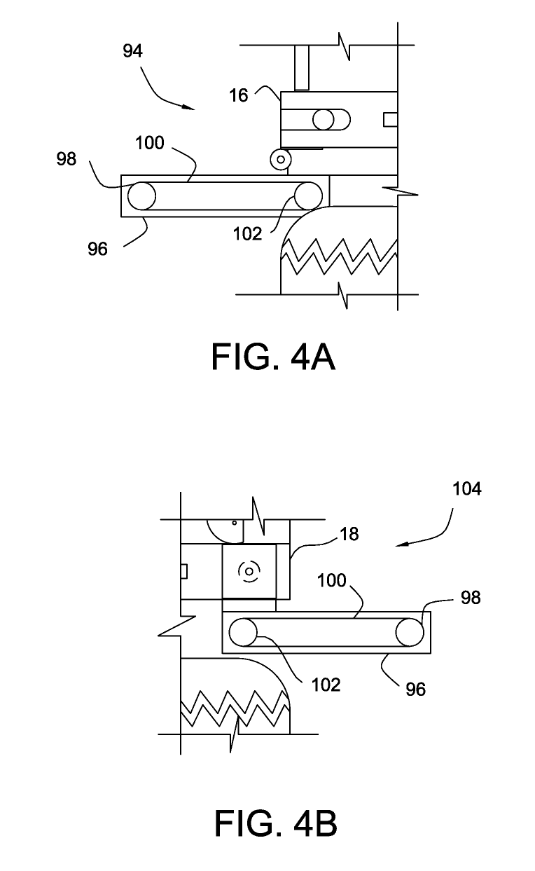

The moving floor hopper 10 may be full of material and the material itself may need to be metered out slowly to meet the quantity requirements during the site placement operation. In order to provide for depositing of the material onto the jobsite at distances which exceed the depositing distance of the main moving floor, a high-speed conveyor as seen in FIGS. 4A and 4B can be utilized for launching the material a distance further away from the moving floor hopper. The high-speed conveyor can be attached at a forward end configuration 94 or at a rearward or aft end configuration 104. The high-speed conveyor has a track 100 with two high-speed conveyor rollers 98 and 102. The rollers extend between two longitudinally aligned side rails 96A and 96B. The conveyor can be operated from the hydraulic controls 32 as seen in FIG. 1 and FIG. 2 where the user actuates the second floor component 40 to operate the track in a forward or rearward direction.

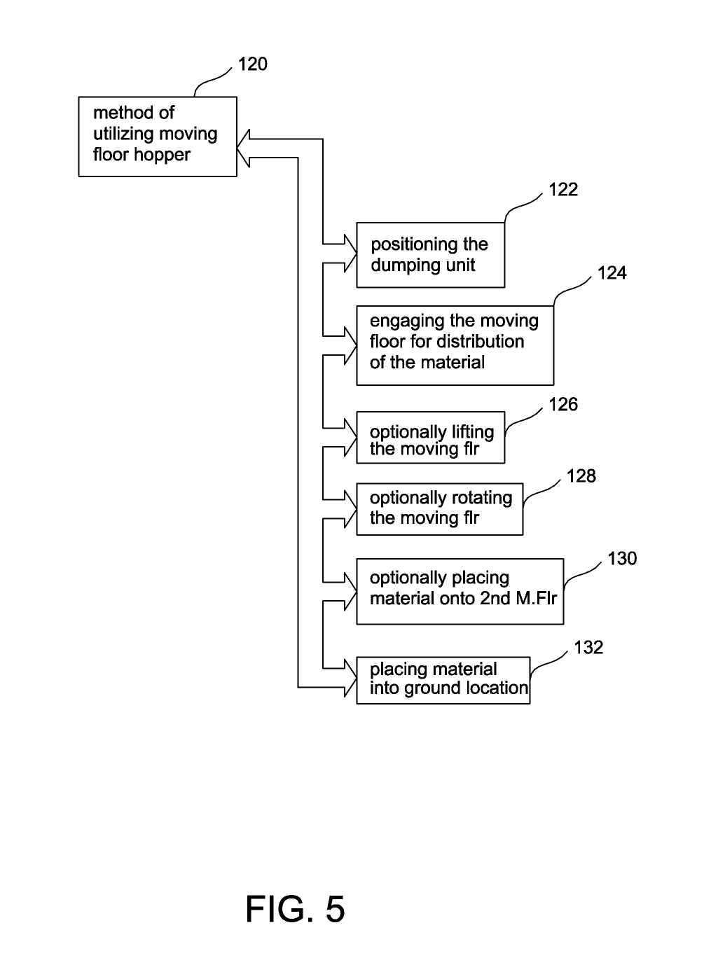

A brief discussion of the method of utilizing the moving floor hopper 120 as seen in FIG. 5 will now be provided. Generally speaking, the operator will position the dumping unit with the moving floor hopper at step 122 by utilizing the controls 30 which include a steering wheel, gearshift, parking brake, and hydraulic joystick to drive the compact articulated site dumper with the moving floor hopper to the location where the material is to be deposited.

This may include in addition to driving the compact articulated site dumper to the location, rotating the moving floor hopper 12 about the turntable 52 by actuating the hydraulic controller or joystick and utilizing the rotate component 38 of the hydraulic controls to turn the moving floor hopper in a radial direction plus or minus 90° from the longitudinal direction of the articulated site dumper.

The user can then engage the moving floor 20 for distribution of the material at step 124. This will include actuating the hydraulic controls 32 to start the floor 62 rotating or moving in the either the forward or rearward direction. The floor hydraulic 70 is exerted with positive or negative pressure through the use of the floor component 34 which controls the direction of the moving floor.

The user may wish to dump the material into a site-specific location. The user can optionally lift the moving floor at step 126 by utilizing the joystick or hydraulic controller 32 and actuate the lift component 36 to radially rotate the moving floor hopper 12 about the forward end 16 around the bed tilt hinge 68. The tilt angle 42 may be between 0 and positive 49°. In tilting, the hydraulic 44 exerts pressure against the lift arm 48 which in turn exerts a rotation pressure or force onto the moving floor hopper tilting the hopper about the bed tilt hinge 68.

During this process, the user may be required to further rotate the moving floor hopper radially about the turntable 52. The user can optionally rotate the moving floor at step 128 again by actuating the rotate component 38 included on the hydraulic controls 32 of the joystick.

In alternative embodiment, the material may need to be placed at a distance which is further away than which the moving floor hopper is able to deposit the material just utilizing the main moving floor bed. In such a case, the user can optionally place material onto the second moving floor at step 130. The second moving floor as previously discussed is a high-speed conveyor 94 which can be placed at the forward or rearward ends of the moving floor. The user can move the material from the slow speed moving floor 62 to the high-speed conveyor 94 or 104 which will launch the material to the desired location. An optional funnel wall is configured to be placed on each of the side walls 16a & 16b to direct the material onto the narrower high speed conveyor.

Once the moving floor hopper has started moving the material out of the hopper itself, the users can place material to the ground location at step 132 and complete the installation of material at the site-specific location.

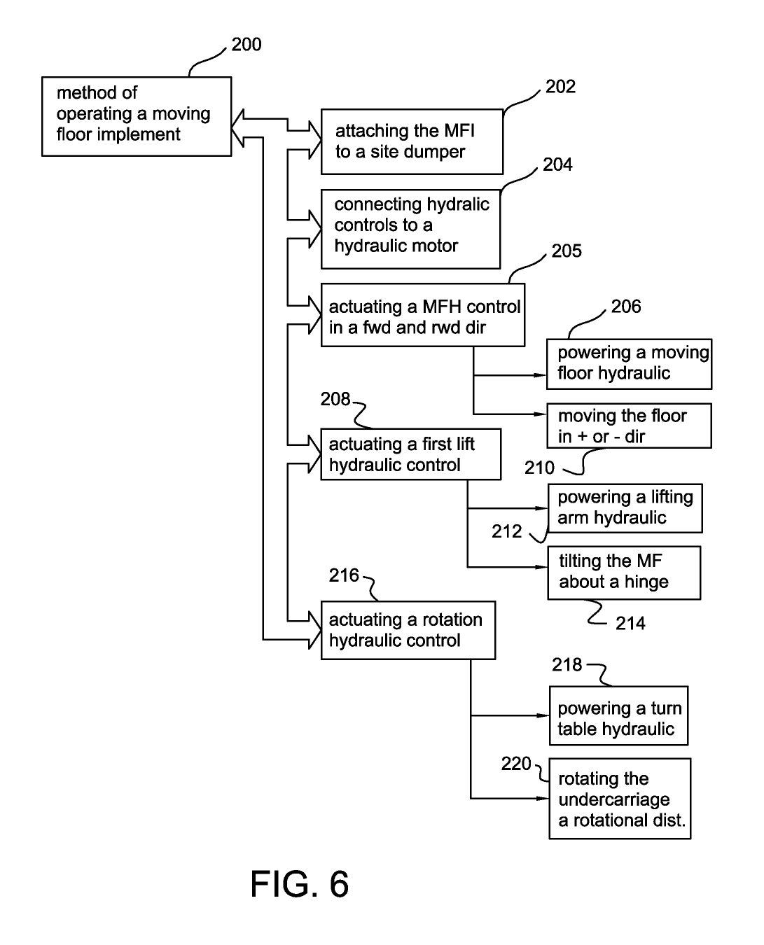

More specifically, a method of operating a moving floor implement 200 as seen in FIG. 6 will now be discussed. A user when modifying a site dumper (for example a compact articulated site dumper) may attach the moving floor implement to the site dumper at step 202. the user will then connect a plurality of hydraulic controls to a hydraulic motor to power the hydraulics at step 204. This would include powering a moving floor hydraulic at step 206, powering a lifting arm hydraulic at step 212, and powering a turntable hydraulic at step 218. The user may actuate a moving floor hydraulic control at step 205 to power the moving floor hydraulic in either a forward direction or a rearward direction. This in turn will move to the floor in a positive or negative direction at step 210.

In addition, the user may actuate the first lift hydraulic control at step 208 to power the first lift arm through a lifting arm hydraulic at step 212. This will tilt the moving floor about the bed tilt hinge at step 214. The user may also actuate a rotation hydraulic control at step 216 to power the undercarriage through the turntable hydraulic at step 218. This in turn will rotate the undercarriage a rotational distance at step 220.

Therefore I claim:

1. A site dumper elevation, rotation, and moving floor hopper implement comprising:
a. a material bed for conveying material from one site location to another; said material bed comprising a bed side wall and a first bed gate; said bed side wall defining an upper bed wall edge and a lower bed wall edge; said material bed further comprising a substantially open top, a bed tilt hinge arranged near said first bed gate;
b. a moving floor for transferring said material towards or away from said first bed gate, said moving floor defining a substantially closed bottom wall of said material bed;
c. a first lift arm configured to tilt said material bed and said moving floor about said bed tilt hinge at an angular distance;
d. an undercarriage configured to support said material bed, said moving floor, and said lift arm; said undercarriage further configured to rotate a rotational distance about a vertically aligned axis.

2. The moving floor hopper implement according to claim 1 wherein said bed side wall further comprises a first longitudinally aligned sidewall and an equal but opposite second longitudinally aligned sidewall; said bed and sidewall further comprising a transverse forward bed wall and a transverse rearward bed wall; said transverse forward bed wall arranged to support said first bed gate.

3. The moving floor hopper implement according to claim 1 wherein said material bed further comprises: a rear bed gate substantially maintained within said transverse rearward bed wall.

4. The moving floor hopper implement according to claim 1 wherein said first bed gate is operable to open and close through actuation of a 12 V linear gate actuator.

5. The moving floor hopper implement according to claim 3 wherein said second bed gate is operable to open and close through actuation of the 12 V linear gate actuator.

6. The moving floor hopper implement according to claim 1 wherein said moving floor further comprises:
a. an endless loop moving floor arranged between two equal but opposite longitudinally aligned floor supports comprising a forward end and a rearward end;
b. said endless loop moving floor configured to rotate about a forward roller bearing arranged at said forward end and a rearward roller bearing arranged at said rearward end.

7. The moving floor hopper implement according to the claim 6 above wherein said first lift arm further comprises:
a. a lower pivot hinge rotatably attached to said undercarriage;
b. an upper pivot hinge rotatably attached to said two equal but opposite longitudinally aligned floor supports at said rearward end;
c. said first lifting arm configured to raise and lower said rearward end of said longitudinally aligned floor supports and said endless loop moving floor about said bed tilt hinge.

8. The moving floor hopper implement according to the claim 7 above wherein said undercarriage further comprises:
d. two equal but opposite longitudinally aligned bracket arms for supporting said longitudinally aligned floor supports at said forward end;
e. a turntable configured to support said longitudinally aligned bracket arms and said lower pivot hinge of said first lift arm; said turntable further configured to provide rotation of said undercarriage, said first lift arm, said longitudinally aligned floor supports, and said endless loop moving floor about a vertical axis said rotational distance.

9. The moving floor hopper implement according to claim 1 wherein said moving floor further comprises: a high-speed conveyor arranged at said forward end of said moving floor to provide increased dispersion of said material during unloading of said material from said hopper through said first bed gate.

10. The moving floor hopper implement according to claim 6 wherein said moving floor further comprises: a plurality of floor rollers interspersed between said forward roller and said rearward roller and spanning between said longitudinally aligned floor supports to provide vertical support and rotational freedom of said endless loop moving floor.

11. The moving floor hopper implement according to claim 1 wherein said first lift arm further comprises: a clamshell hydraulic driven lift arm.

12. The moving floor hopper implement according to claim 1 wherein said moving floor further comprises: a hydraulically driven moving floor.

13. The moving floor hopper implement according to claim 8 wherein said turntable further comprises: a hydraulically driven turntable configured to rotate said rotational distance.

14. The moving floor hopper implement according to claim 13 wherein said undercarriage further comprises: said rotational distance comprising at most about 180°.

15. The moving floor hopper implement according to claim 1 wherein said first lift arm further comprises: said angular distance comprising at most about 90°.

16. The moving floor hopper implement according to claim 1 wherein said moving floor hopper implement further comprises: a scissor lift configured to raise said material bed and said moving floor while enabling said first lift arm to rotate said material bed about said upper pivot hinge of said first lift arm.

17. The moving floor hopper implement according to claim 1 wherein said moving floor hopper implement further comprises: a plurality of hydraulic controls configured to operate said moving floor, operate said first lift arm, operate said undercarriage.

18. A method of operating a moving floor hopper implement said method comprising:
a. attaching a moving floor hopper implement onto a site dumper;
b. connecting a plurality of hydraulic controls to a hydraulic motor for powering: a moving floor hydraulic; a lifting arm hydraulic; a turntable hydraulic;
c. actuating a moving floor hydraulic control to power a moving floor through said moving floor hydraulic in a forward or rearward direction; said moving floor comprising an endless loop moving floor arranged between two equal but opposite longitudinally aligned floor supports comprising a forward end and a rearward end; said endless loop moving floor rotating about a forward roller bearing arranged at said forward end and a rearward roller bearing arranged at said rearward end;
d. actuating a first lift hydraulic control to power a first lift arm through said lifting arm hydraulic to tilt said moving floor about a bed tilt hinge positioned at said forward end;
e. actuating a rotation hydraulic control to power an undercarriage through said turntable hydraulic to rotate said undercarriage a rotational distance about a vertically aligned axis; said undercarriage supporting said moving floor and said lift arm.

19. The method according to claim 18 wherein said method further comprises:
a. raising said rearward end of said longitudinally aligned floor supports and said endless loop moving floor by rotating said first lift arm configured as a clamshell hydraulic lift arm about said lower pivot hinge rotatably attached to said undercarriage;
b. rotating said first lift arm about an upper pivot hinge rotatably attached to said longitudinally aligned floor supports at said rearward end.

20. The method according to claim 18 wherein said method further comprises: actuating a high speed moving floor hydraulic control to power a high-speed conveyor arranged at said forward end of said moving floor; providing increased dispersion of said material during unloading of said material from said moving floor hopper implement.

21. The method according to claim 18 wherein said method further comprises: said undercarriage supporting said moving floor and said lift arm by utilizing two equal but opposite longitudinally aligned bracket arms to support said longitudinally aligned floor supports at said forward end.

22. The method according to claim 21 wherein said method further comprises: said undercarriage supporting said longitudinally aligned bracket arms by utilizing a turntable interoperating with said turntable hydraulic to rotate said undercarriage, said first lift arm, said longitudinally aligned floor supports, and said endless loop moving floor about said vertically aligned axis.

23. The method according to claim 18 wherein said method further comprises: rotating said endless loop moving floor about a plurality of floor rollers interspersed between said forward roller and said rearward roller said plurality of rollers spanning between said longitudinally aligned floor supports providing vertical support and rotational freedom of said endless loop moving floor.

24. The method according to claim 18 wherein said method further comprises: actuating a second lift hydraulic control to power a scissor lift through a scissor lift hydraulic to lift said moving floor.

25. A compact articulated site dumper in combination with an implement driven moving floor hopper said combination comprising:
a. an articulated chassis arranged along a longitudinal axis and comprising a set of front drive wheels and a set of rear drive wheels, an operator's seat comprising a plurality of hydraulic controls, a steering drive, a break, an accelerator; a hydraulic motor arranged at a rear end of said compact articulated site dumper (CASD);
b. an undercarriage arranged at a forward end of said CASD substantially above said set of front drive wheels; said undercarriage configured to rotate a rotational distance about a vertically aligned axis through actuation of said plurality of hydraulic controls and powering of said hydraulic motor; said undercarriage configured to support a first lift arm, a moving floor, and a material bed;
c. said material bed configured to convey material within a hold from one site location to another as transported by the CASD; said moving floor configured to transfer said material towards or away from a first bed gate located within said material bed, said moving floor defining a substantially closed bottom wall of said material bed;
d. said first lift arm configured to tilt said material bed and said moving floor about a bed tilt hinge at an angular distance, said bed tilt hinge arranged below said first bed gate.
